(19) United States
(12) Patent Application Publication
(10) Pub. No.: US 2004/0112427 A1
(43) Pub. Date: Jun. 17, 2004

(54) Hydrogen distribution systems and methods

(75) Inventor: Andrew Klassen, North Vancouver (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Generation Systems, Burnaby (CA)

(21) Appl. No.: 10/321,705

(22) Filed: Dec. 16, 2002

(51) Int. Cl. F17D 1/00

(52) U.S. Cl. 137/1; 137/583

(57) ABSTRACT

Systems and methods for distributing hydrogen. A fuel is supplied in a pipe, and a stream comprising hydrogen is injected into the pipe. Hydrogen is extracted from the pipe downstream of the injection point.

### BACKGROUND OF THE INVENTION

1. Field of the Invention

The present invention relates generally to systems and methods for distributing hydrogen.

2. Description of the Related Art

As a clean and efficient manner of generating electricity, electrochemical fuel cells—particularly those that operate using hydrogen—have been the focus of considerable attention over the last decade. However, one challenge to the commercialization of electrochemical fuel cells has been and continues to be the development of an efficient and economical means for supplying hydrogen to consumers.

Although distribution systems employing a network of pipelines for delivering fuel, such as natural gas, propane or liquefied petroleum gas (LPG), presently exist, there is presently no such network for the distribution of hydrogen, and a method for supplying hydrogen to a geographically widespread area is needed. Many proposals have focused on a decentralized distribution system in which hydrogen is produced locally at numerous refueling points, either through the utilization of hydrocarbon fuels and fuel reforming technologies or through the electrolysis of water.

To date, a comprehensive plan for developing a hydrogen distribution infrastructure has not been determined. Accordingly, there remains a need in the art for an efficient and economical method for supplying hydrogen to a geographically widespread area.

### BRIEF SUMMARY OF THE INVENTION

A method of hydrogen distribution is disclosed. The method comprises (i) supplying a fuel in a pipe, (ii) injecting a first stream comprising hydrogen into the pipe at a first point, and (iii) extracting hydrogen from the pipe at a second point, wherein the second point is located downstream of the first point.

In another embodiment, a hydrogen distribution system is disclosed. The system comprises a pipe adapted to contain a fuel, a means for injecting a stream comprising hydrogen into the pipe, and a means for extracting hydrogen from the pipe, wherein the means for extracting hydrogen from the pipe is located downstream of the means for injecting the stream comprising hydrogen into the pipe.

These and other aspects of the present distribution systems and methods will be apparent upon reference to the attached figures and following detailed description.

### BRIEF DESCRIPTION OF THE SEVERAL VIEWS OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1 is a schematic drawing of a portion of an embodiment of the present hydrogen distribution system.

FIG. 2 is a schematic drawing of a portion of a further embodiment of the system of FIG. 1.

FIG. 3 is a schematic drawing of a portion of yet a further embodiment of the system of FIG. 1.

### DETAILED DESCRIPTION OF THE INVENTION

In the following description, certain specific details are set forth in order to provide a thorough understanding of various embodiments of the present systems and methods. However, persons skilled in the art will understand that the present systems and methods may be practiced without these details. In other instances, certain well known structures have not been described in detail, such as those associated with hydrogen production, electrolyzers, reformers, shift reactors and separators, to avoid unnecessarily obscuring the descriptions of the embodiments of the present systems and methods.

Unless the context requires otherwise, throughout the specification and claims which follow, the word “comprise” and variations thereof, such as “comprises” and “comprising” are to be construed in an open, inclusive sense, that is as “including but not limited to.”

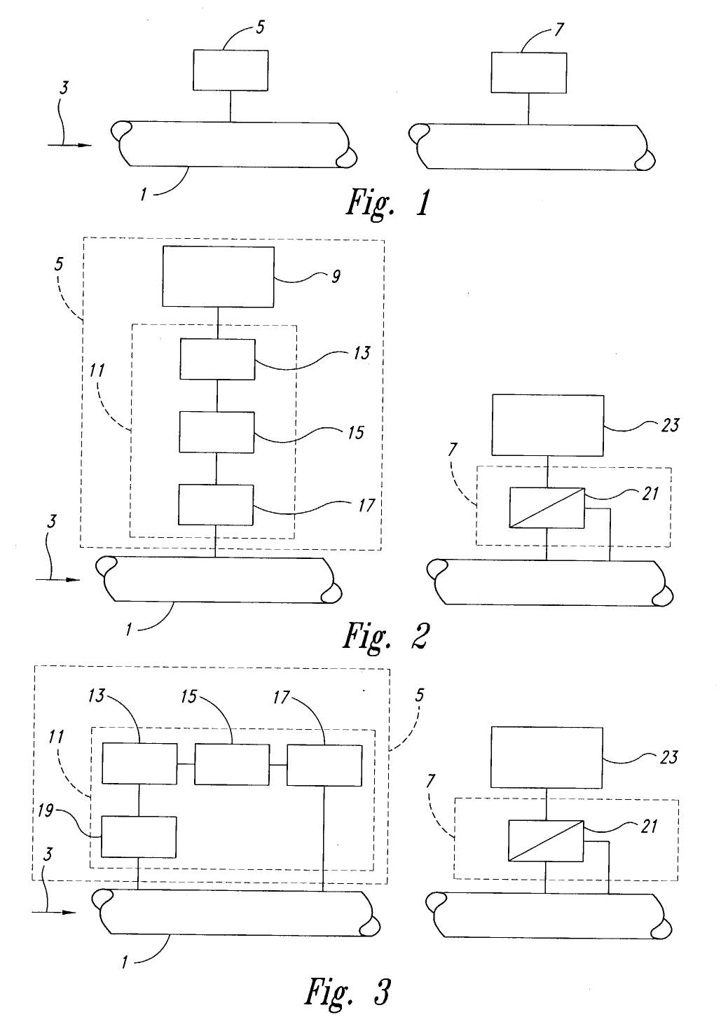

FIG. 1 illustrates a portion of an embodiment of the present hydrogen distribution system. As shown, a pipe 1 is adapted to contain, and during operation of the system contains, a fuel, such as natural gas, propane or liquefied petroleum gas (“LPG” ). Pipe 1 is connected to a means 5 for injecting a hydrogen containing stream into pipe 1.

In FIG. 1, pipe 1 has a circular cross-section, however, the cross-sectional shape of pipe 1 is not essential to the present systems and methods. Similarly, the material of pipe 1 is not essential to the present systems and methods, and persons of ordinary skill in the art can readily choose a pipe suitable for a given application. Furthermore, one of ordinary skill in the art will appreciate that a number of different means 5 may be utilized for injecting the hydrogen containing stream into pipe 1 and that the specific components of means 5 are not essential to the present systems and methods. Acceptable means 5 for injecting the hydrogen containing stream into pipe 1 may comprise a number of different sources for the hydrogen. For example, means 5 may comprise (i) a hydrogen supply directly and fluidly connected to pipe 1, (ii) an electrolyzer, adapted to produce hydrogen from water, fluidly connected to pipe 1, (iii) a hydrogen enrichment generator, adapted to produce a hydrogen enriched fluid from a fuel supply, fluidly connected to both pipe 1 and the fuel supply, as further illustrated by the embodiment of FIG. 2, or (iv) a hydrogen enrichment generator, adapted to withdraw an amount of the fuel from pipe 1 and convert the fuel to a hydrogen enriched fluid, fluidly connected to pipe 1 at two points, as further illustrated by the embodiment of FIG. 3.

As further shown in FIG. 1, pipe 1 is also connected to a means 7 for extracting hydrogen from the mixture of the fuel and hydrogen in pipe 1. As with means 5, one of ordinary skill in the art will appreciate that a number of different means 7 may be utilized to extract the hydrogen from pipe 1 and that the specific components of means 7 are not essential to the present systems and methods. Means 7 may comprise a hydrogen separator fluidly connected to pipe 1, as further illustrated by the embodiments of FIGS. 2 and 3. Furthermore, in an alternate embodiment of the present distribution system, a number of means 7 may be connected to pipe 1 at different points along pipe 1. This configuration enables many users to benefit from a single hydrogen source or production system and avoids the need for each user to produce or store hydrogen locally.

In the illustrated embodiment, means 7 is located downstream of means 5, with respect to the direction (as illustrated by arrow 3 in FIG. 1) of the flow through pipe 1. In this way, the use of means 5 and means 7 together enables the hydrogen to be transported between a number of points along pipe 1. More specifically, at a first upstream point, means 5 may be utilized to generate a stream of fuel flowing through pipe 1 that is enriched with hydrogen. One or more means 7 may then be utilized to withdraw the hydrogen from this enriched fluid stream at one or more later downstream points.

FIG. 2 illustrates a portion of a further embodiment of the distribution system illustrated in FIG. 1. In the more specific embodiment illustrated in FIG. 2, the distribution system is a hydrogen distribution system in which means 5 of FIG. 1 comprises a hydrogen enrichment generator 11 and means 7 of FIG. 1 comprises a hydrogen separator 21. As shown, hydrogen enrichment generator 11 and hydrogen separator 21 are both fluidly connected to pipe 1.

Hydrogen enrichment generator 11 comprises a reformer 13 and may further comprise a shift reactor 15 and/or a selective oxidation reactor 17 depending on the specific system requirements. In the embodiment illustrated in FIG. 2, hydrogen enrichment generator 11, specifically reformer 13, is also fluidly connected to a fuel supply 9 and reformer 13 is adapted to produce a hydrogen enriched fluid from fuel supply 9.

As shown in FIG. 2, means 7 comprises a hydrogen separator 21 which is fluidly connected to pipe 1 at two points. In this way, hydrogen separator 21 is adapted to (i) withdraw a slip of the hydrogen enriched fuel flowing through pipe 1, (ii) extract hydrogen from the enriched fuel, (iii) supply the extracted hydrogen to a user 23 and (iv) re-inject the fuel, which may be enriched with a residual amount of hydrogen, into pipe 1. Users of the hydrogen may include consumers, re-fueling stations, factories, etc.

In the embodiment illustrated in FIG. 2, hydrogen enrichment generator 11 is located upstream, with respect to the direction of the flow (represented by arrow 3) through pipe 1, of hydrogen separator 21. In this way, the use of hydrogen enrichment generator 11 and hydrogen separator 21 together enables hydrogen to be transported between a number of points along pipe 1 in the same manner as described above in more detail with respect to FIG. 1.

FIG. 3 illustrates a portion of yet a further embodiment of the distribution system illustrated in FIG. 1. As in FIG. 2, in the embodiment illustrated in FIG. 3, the distribution system is a hydrogen distribution system in which means 5 of FIG. 1 comprises a hydrogen enrichment generator 11 and means 7 of FIG. 1 comprises a hydrogen separator 21. Furthermore, as shown in FIG. 3, hydrogen enrichment generator 11 and hydrogen separator 21 are both fluidly connected to pipe 1.

Also similar to FIG. 2, in the embodiment illustrated in FIG. 3, hydrogen enrichment generator 11 comprises a reformer 13 and may further comprise a shift reactor 15 and/or a selective oxidation reactor 17 depending on the specific system requirements. However, in the embodiment illustrated in FIG. 3, hydrogen enrichment generator 11 is fluidly connected to pipe 1 at two points and is adapted to withdraw a stream of the fuel from pipe 1 and convert the fuel to a hydrogen enriched fluid. In this way, a separate fuel supply, such as fuel supply 9 of FIG. 2, is unnecessary.

Additionally, hydrogen enrichment generator 11 may optionally comprise an odorant separator 19 that is adapted to remove any odorants from the fuel. For example, if the fuel is natural gas, propane or LPG, it is likely that sulfur compounds, such as mercaptans and thiophenes, will have been added to the fuel to assist in the detection of fluid leaks. These odorants may be removed before the fuel reaches reformer 13. As shown in FIG. 3, any odorants are rejected directly back into pipe 1.

Hydrogen separator 21 of FIG. 3 is identical to hydrogen separator 21 of FIG. 2. Specifically, hydrogen separator 21 is fluidly connected to pipe 1 at two points and is adapted to (i) withdraw a slip of the hydrogen enriched fuel stream flowing through pipe 1, (ii) extract hydrogen from the enriched fuel, (iii) supply the extracted hydrogen to a user 23 and (iv) re-inject the fuel, which may be enriched with a residual amount of hydrogen, into pipe 1.

Finally, as in FIG. 2, in the embodiment illustrated in FIG. 3, hydrogen enrichment generator 11 is located upstream, with respect to the direction of the flow (represented by arrow 3) through pipe 1, of hydrogen separator 21. In this way, the use of hydrogen enrichment generator 11 and hydrogen separator 21 together enables hydrogen to be transported between a number of points along pipe 1 in the same manner as described above in more detail with respect to FIG. 1.

As described, the present systems and methods provide for a simple and efficient distribution of hydrogen, using the distribution network of another fuel, such as natural gas, propane or LPG. Furthermore, the present systems and methods can be adapted to utilize existing distribution systems for fuels, such as those already in place for distributing natural gas, propane and LPG. When such an existing distribution system is utilized, residual amounts of hydrogen may ultimately be consumed in the same manner as the carrier fuel (i.e. burning in conventional devices). Accordingly, one of ordinary skill in the art will appreciate that the presence and amount of the hydrogen injected into pipe 1 should not result in a material change in the characteristics of the carrier fuel, such as a substantial change in the heating value of the mixture that ultimately reaches consumers of the fuel.

Similarly, it will be understood by persons of ordinary skill in the art that the pipe material be selected to accommodate both the fuel and mixtures of the fuel and hydrogen. Accordingly, in one embodiment, the amount of hydrogen injected by means 5 may be monitored and/or controlled to maintain the concentration of hydrogen such that the mixture can be accommodated by the pipe material.

From the foregoing it will be appreciated that specific embodiments of the invention have been described herein for purposes of illustration, and various modifications may be made without deviating from the spirit and scope of the invention. Accordingly, the invention is not limited except as by the appended claims.

What is claimed is:

1. A hydrogen distribution method, comprising:
supplying a fuel in a pipe;
injecting a first stream comprising hydrogen into the pipe at a first point; and
extracting hydrogen from the pipe at a second point,
wherein the second point is located downstream of the first point.

2. The method of claim 1 wherein the pipe is part of a distribution system for the fuel and wherein the fuel is selected from the group consisting of natural gas, propane and liquefied petroleum gas.

3. The method of claim 2, further comprising:
withdrawing fuel from the pipe at a third point; and
producing the first stream comprising hydrogen from the withdrawn fuel,
wherein the third point is located upstream of the first point.

4. A hydrogen distribution system, comprising:
a pipe adapted to contain a fuel,
a means for injecting a stream comprising hydrogen into the pipe; and
a means for extracting hydrogen from the pipe,
wherein the means for extracting hydrogen from the pipe is located downstream of the means for injecting the stream comprising hydrogen into the pipe.

5. The system of claim 4 wherein the pipe is part of a distribution system for the fuel and wherein the fuel is selected from the group consisting of natural gas, propane and liquefied petroleum gas.

6. The system of claim 5 wherein the means for extracting hydrogen from the pipe comprises a hydrogen separator fluidly connected to the pipe.

7. The system of claim 5 wherein the means for injecting the stream comprising hydrogen into the pipe comprises an electrolyzer fluidly connected to the pipe.

8. The system of claim 5 wherein the means for injecting the stream comprising hydrogen into the pipe comprises a hydrogen enrichment generator fluidly connected to the pipe.

9. The system of claim 8 wherein the hydrogen enrichment generator comprises a reformer.

10. The system of claim 9 wherein the hydrogen enrichment generator further comprises a shift reactor.

11. The system of claim 10 wherein the hydrogen enrichment generator further comprises a selective oxidation reactor.

12. The system of claim 8 wherein the hydrogen enrichment generator is adapted to withdraw fuel from the pipe and convert the withdrawn fuel to a stream comprising hydrogen.

13. The system of claim 12 wherein the hydrogen enrichment generator comprises an odorant separator.
